(19) United States
(12) Patent Application Publication
(10) Pub. No.: US 2002/0171855 A1
(43) Pub. Date: Nov. 21, 2002

(54) Automated sharpening of images for soft proofing

(76) Inventor: Christopher J. Edge, St. Paul, MN (US)

Correspondence Address: SHUMAKER & SIEFFERT, P. A., 8425 SEASONS PARKWAY, SUITE 105, ST. PAUL, MN, 55125, US

(21) Appl. No.: 10/113,830

(22) Filed: Mar. 29, 2002

Related U.S. Application Data
(60) Provisional application No. 60/280,184, filed on Mar. 30, 2001.

(51) Int. Cl. B41J 1/00

(52) U.S. Cl. 358/1.9

(57) ABSTRACT

Automated sharpening of images for soft proofing involves dynamic adjustment of the degree of sharpening applied to soft proof images based on the magnification factor applied by the display device. The appearance of image detail in a soft proof image can vary based on the magnification factor applied to the image. Sharpening of the original high resolution RGB image data may not be required if significant zooming is employed. When reduced magnification is required, however, much of the image detail can be lost. In this case, dynamic image sharpening helps to compensate for the reduced magnification, and thereby preserve the appearance of detail for the viewer. In particular, the degree of image sharpening may be adjusted in a generally inverse proportion to the magnification factor, providing an adaptive sharpening function.

This application claims priority from U.S. provisional application serial No. 60/280,184, filed Mar. 30, 2001, the entire content of which is incorporated herein by reference.

### TECHNICAL FIELD

The invention relates to color imaging and, more particularly, to techniques for soft proofing of images on display devices.

### BACKGROUND

The term “soft proofing” generally refers to the use of a display device, such as a CRT or flat panel monitor, to proof the appearance of color images before reproducing the images on a printing press or other high volume printing device. One of the barriers to soft proofing commercialization has been the difficulty in achieving a color match between colors presented in a hard copy print versus those presented on a display device. Recent technological developments have greatly improved the color matching capabilities of soft proofing systems. As color matching improves, however, viewers may notice other differences between hard copy images and the images presented by display devices.

### SUMMARY

The invention is directed to techniques for automated sharpening of images for soft proofing. In particular, the invention involves dynamic adjustment of the degree of sharpening applied to soft proof images based on a magnification factor applied to the image.

Once improved color matching is achieved, viewers can begin to notice differences in detail, sharpness, and contrast between images rendered on display devices and hard copy media. These differences may arise in part due to the relatively low resolution of the display device, which ordinarily is no more than 100 dpi (dots per inch). In contrast, hard copy devices such as inkjet printers routinely exceed resolutions of 300 dpi. In addition, slight bloom and lack of edge precision in pixels produced by a display device can cause other visible differences in the soft proof image.

The visible differences in the soft proof image can vary based on the magnification factor applied to the image. Sharpening of the original high resolution RGB image data may not be required if significant zooming is employed. If a 300% or 400% magnification is permitted, for example, image detail may appear clearly to the viewer. When reduced magnification is required, however, much of the image detail can be lost. In this case, image sharpening helps to compensate for the reduced magnification, and thereby preserve the appearance of detail for the viewer. In particular, in accordance with the invention, the degree of image sharpening may be adjusted in inverse proportion to the magnification factor.

In accordance with the invention, the degree of sharpening is controlled based on the magnification factor of the image presented by the display device. In this manner, the degree of sharpening automatically and dynamically adapts to the degree of magnification. For higher magnification factors, the invention applies a reduced degree of sharpening. For lower magnification factors, the invention applies an increased degree of sharpening. In each case, the invention provides a degree of sharpening that delivers a more acceptable appearance given the then-existing magnification factor applied at the display device.

The degree of sharpening and magnification factor may be correlated by a mathematical function or lookup table that maps magnification factor values to sharpening values. When the magnification factor for an image changes, the corresponding sharpening value can be calculated or retrieved and applied to the sharpening algorithm, e.g., as a coefficient or offset.

The dynamic sharpening process can be employed automatically in the software utilized to view the image. The sharpening process preferably is responsive to dynamic changes in the magnification factor so that modifications to the sharpening coefficient appear substantially instantaneously to the user as he views the magnified image.

In one embodiment, the invention provides a method comprising applying a sharpening function to an image, and controlling the sharpening function based on a magnification factor associated with the image.

In another embodiment, the invention provides a system comprising a display device that displays a representation of a color image, and a processor that applies a sharpening function to the image, wherein the processor controls the sharpening function based on a magnification factor associated with the image.

In an added embodiment, the invention provides a computer-readable medium containing instructions that cause a programmable processor to apply a sharpening function to an image, and control the sharpening function based on a magnification factor associated with the image when presented on a display device.

In some embodiments, the automated sharpening function may be accompanied by an offset correction that provides more appropriate characterization of dark colors. When a region of RGB=0 is displayed, for example, measurement instruments may indicate no detectable light. To the human observer, however, there may be a faint appearance of gray in those regions, particularly when adjacent regions have an RGB value of greater than zero. Incorporation of an offset correction for lower values of RGB addresses this issue, and can further improve appearance, especially when combined with an automated sharpening function.

The automated sharpening function also may be accompanied by optimized scaling of the image data when rendered to a low resolution display. Non-optimized scaling, such as pixel sampling, is often used in image editing applications because of speed and simplicity. For optimal quality, a soft proofing system as described herein may combine sharpening, either fixed or preferably dynamic, with optimized scaling such as bicubic interpolation. More particularly, the system may offer multiple operating modes that balance processing speed and optimal results. Alternatively, the system may offer one or more of the operating modes.

For example, a system can be configured to provide a fixed mode in which the magnification factor is fixed, and a variable mode in which the magnification factor is varied. In the fixed mode, optimal scaling may be combined with fixed optimal sharpening. In the variable mode, the system may be configured to provide generic scaling in combination with dynamic optimal sharpening that varies as a function of magnification factor. Alternatively, the system may provide an optimal mode in which optimal scaling is combined with dynamic optimal sharpening to provide optimal flexibility and quality. A system also may be configured to offer two or more of the operating modes on a selective basis.

In one embodiment, the invention provides a method comprising selecting one of a plurality of operating modes for a soft proofing system, selecting a scaling function for an image to be presented by the soft proofing system based on the selected operating mode, and selecting a sharpening function for the image based on the selected operating mode.

In another embodiment, the invention provides a system comprising a display device that displays a representation of a color image, and a processor that selects one of a plurality of operating modes, selects a scaling function for an image to be presented by the soft proofing system based on the selected operating mode, and selects a sharpening function for the image based on the selected operating mode.

In an added embodiment, the invention provides a computer-readable medium comprising instructions that cause a programmable processor to select one of a plurality of operating modes for a soft proofing system, select a scaling function for an image to be presented by the soft proofing system based on the selected operating mode, and select a sharpening function for the image based on the selected operating mode.

The details of one or more embodiments of the present invention are set forth in the accompanying drawings and the description below. Other features, objects, and advantages of the present invention will be apparent from the description and drawings, and from the claims.

### BRIEF DESCRIPTION OF DRAWINGS

FIG. 1 is a block diagram illustrating an example soft proofing system.

FIG. 2 is a flow diagram illustrating dynamic sharpening of a color image as a function of magnification factor.

FIG. 3 is a flow diagram illustrating scaling and sharpening of a color image in multiple operating modes.

### DETAILED DESCRIPTION

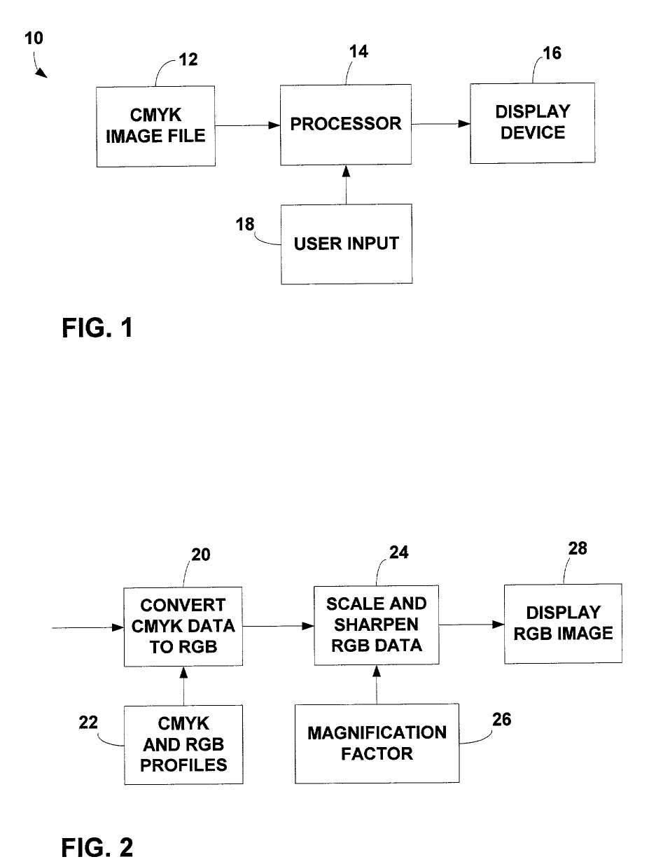

FIG. 1 is a block diagram illustrating an example soft proofing system 10. As shown in FIG. 1, system 10 may include a media device 12 providing access to one or more CMYK (cyan, magenta, yellow, black) image files, a processor 14 for converting CMYK image files to RGB (red, green, blue) image files, a display device 16 for displaying color images prepared by the processor, and a user input device 18 for adjusting the magnification factor and other characteristics of images presented by the display device. Processor 14 may be programmed to scale the image data as necessary, e.g., based on the resolution of the image data, the resolution of display device 16, and the desired magnification, and execute a dynamic sharpening process that adjusts the characteristics of a sharpening function applied to the RGB images as a function of the magnification factor of the images when presented on display device 16.

As an example, media device 12 may take the form of a fixed hard drive or removable media device storing image files. Alternatively, media device 12 may represent a network connection with a link or path to particular image files. Processor 14 may form part of a general-purpose computer, such as a personal computer or workstation, that is programmed to control display of images on display device 16 for use in soft proofing applications. Display device 16 may take the form of a CRT, LCD, plasma, or other display device. User input device 18 may include a conventional keyboard and pointing device such as a mouse, pen, or trackball, if desired.

FIG. 2 is a flow diagram illustrating sharpening of a color image for soft-proofing. The sharpening process shown in FIG. 2 can be implemented in system 10, and may involve dynamic sharpening of a color image as a function of an applied magnification factor. As shown in FIG. 2, processor 14 may first convert CMYK data to RGB data (20). The CMYK data can be obtained from a CMYK image file accessible on media device 12. CMYK image files are typically more appropriate for rendering of hard copy images, whereas RGB image files are typically more appropriate for soft proofing on display device 16. In some embodiments, the RGB data can be obtained by conversion from other types of image files, including high-fidelity (such as CMYKOG i.e., cyan, magenta, yellow, black, orange, green) image files, device-independent (XYZ or L*a*b*), or native RGB files.

To aid in conversion, processor 14 may access CMYK and RBG profiles (22). The profiles may be ICC profiles that define the color response characteristics of source CMYK and destination RGB devices for accurate color matching. Upon conversion to RGB data, the process may include scaling and sharpening (24). The scaling operation involves interpolation or sampling of the RGB image data to a resolution appropriate for presentation on display device 16. When the scaling is unspecified, the term “generic scaling” may be used. If a high quality appearance is required, “optimal scaling” should be employed. An example of optimal scaling is bicubic interpolation. In general, optimal scaling refers to a scaling function that provides interpolation of pixel data, i.e., interpolation-based scaling. Interpolation-based, optimal scaling, in contrast to sampling, does not eliminate pixel information in its entirety. “Nearest neighbor” sampling is an example of non-optimal, non-interpolation-based scaling function. Sampling generally suffers from the loss of pixel information and introduction of artifacts. Sharpening involves the application of a sharpening function to the scaled RGB data to better preserve the appearance of detail in the image presented on display device 16.

The sharpening function, in accordance with the invention, may vary according to the magnification factor applicable to the RGB image data (26). If this option is enabled, as the magnification factor changes, the degree of sharpening applied to the RGB image data changes. Upon application of the scaling and sharpening functions, the RGB image data is displayed as an RGB image on display device 16 (28). The sharpening function may be reapplied each time the user changes the magnification factor by adjusting the zoom. Alternatively, the sharpening function may be reapplied in the event the magnification factor changes by an amount deemed sufficient to cause the formation of visible artifacts in the displayed image.

Thus, the invention can function with one or more of several modes of simplicity or complexity depending on the requirements of the specific soft-proofing system. For example, an image may be subjected to a first mode (1) involving optimal scaling followed by fixed optimal sharpening, e.g., for use with a fixed magnification factor (fixed mode). Alternatively, the image may be subjected to a second mode (2) involving generic scaling followed by dynamic optimal sharpening, e.g., for general use with variable magnification (variable mode). As a further alternative, the image may be subjected to a third mode (3) involving optimal scaling followed by dynamic optimal sharpening, e.g., for optimal flexibility and quality (optimal mode). A user of system 10 may configure the system to operate in one or more of the above modes on a selective basis.

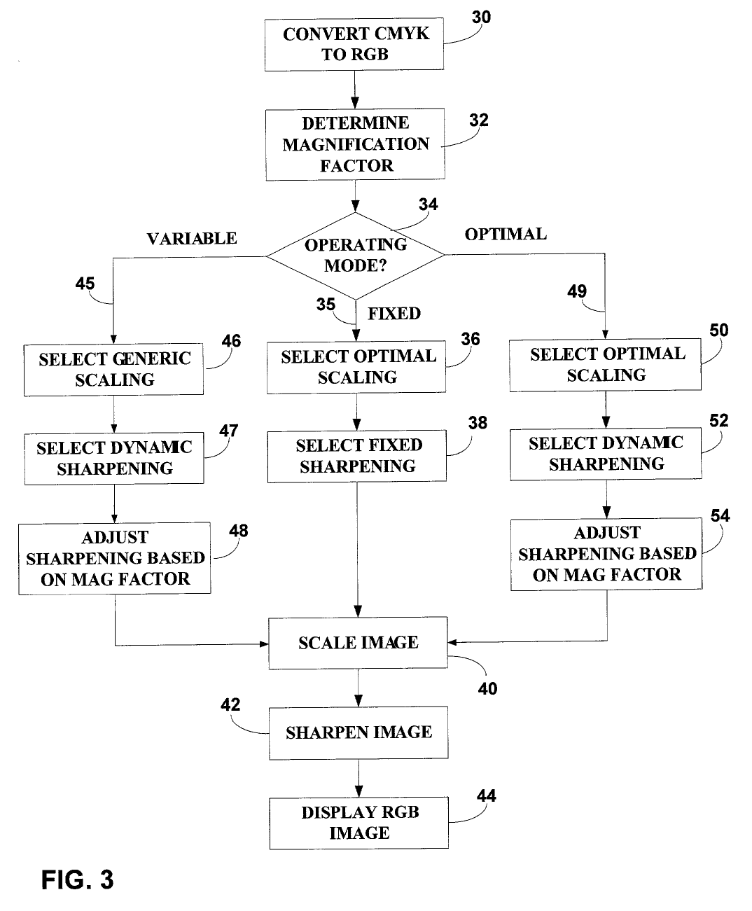

FIG. 3 is a flow diagram illustrating scaling and sharpening of a color image using multiple operating modes. As shown in FIG. 3, processor 14 may first convert CMYK data to RGB data (30), and then determine an applicable magnification factor for the image (32). Processor 14 identifies which of a plurality of operating modes have been selected for the image (34). The operating modes may be user-selectable or automatically selected based on metadata, tags, or other control or descriptive information associated with the image. As described above, the modes may include a fixed mode, variable mode and optimal mode. Upon selection of the fixed mode (35), indicating fixed magnification, processor 14 selects an optimal, i.e., interpolation-based scaling function (36) such as bicubic interpolation, and selects a fixed sharpening function (38). Processor 14 then scales (40) and sharpens (42) the image for display on display device 16 (44).

As further shown in FIG. 3, upon selection of the variable mode (45) in which the magnification factor may vary, processor 14 selects a generic scaling function (46), which may be optimal or sub-optimal, i.e., interpolation-based or sampling-based, respectively. In other words, the selected scaling function is not limited to optimal functions such as bicubic interpolation, but may include other scaling functions such as “nearest neighbor” sampling. Processor 14 also selects a dynamic sharpening function (47), as described herein, and then adjusts the sharpening function according to the magnification factor (48). Processor then proceeds to scale the image (40), sharpen the image (42), and display the image (44) on display device 16.

Upon selection of the optimal mode (49), processor 14 selects an optimal scaling function (50), such as bicubic interpolation. Processor 14 also selects a dynamic sharpening function (52) that varies according to the magnification factor. Upon adjusting the sharpening function based on the magnification factor (54), processor 14 scales the image (40), sharpens the image (42), and displays the image (44) on display device 16. In the optimal operating mode, system 10 delivers optimal scaling and sharpening to promote enhanced image quality without regards to associated processing overhead.

Although FIG. 3 depicts the use of multiple operating modes on a selective basis, the invention also contemplates a soft proofing system providing a single operating mode, or perhaps two operating modes. The operating mode or modes may be selected for a given system, for example, based on a balance between processing speed and image appearance.

A manual approximation of the automated conversion, scaling and sharpening of an image, in accordance with the invention, can be demonstrated in the Adobe PhotoShop™ software application by the following steps. The demonstration illustrates in a manual fashion an embodiment of the invention that performs a similar process in an automatic, predetermined way that is transparent to the user. To display a representation of a CMYK image on an RGB display device for soft proofing, the display is first set to a maximum resolution, e.g., 1600×1200 (100 dpi). Next, the CMYK image can be converted to RGB. The conversion of CMYK pixels to RGB may rely on accurate profiles, such as ICC profiles, for the CMYK system and the RGB behavior of display device 16.

In this manner, an accurate color match can be obtained between the CMYK image rendered on a hard copy device and the RGB image rendered on a display device. Then, a scaling algorithm is applied to convert the resolution of the RGB image data to the actual pixel resolution of the display device (scaled appropriately for the desired magnification factor). The bicubic sampling provided in Adobe Photoshop™ software has been found to be a suitable scaling algorithm for many applications. The Adobe Photoshop software is commercially available from Adobe Systems, Inc., of San Jose, Calif.

Note that the “nearest neighbor” sampling option can be shown to be less optimal than the bicubic interpolation option. An easy demonstration of this fact can be performed by converting test images from current size (100%) to 50% and back again to 100% for each of the two options for scaling. The resulting image can be compared to the original image. The degree of error will typically be +/−23% for a complex worst case image using nearest neighbor vs. +/−18% for bicubic. However, if quality is of lesser importance than processing speed, nearest neighbor or some other “generic scaling” can be used. This would be appropriate for an fixed operating mode (1) involving optimal scaling followed by fixed optimal sharpening, as described above.

Sharpening is then applied to the resulting color accurate RGB image. As an example, the “Sharpen More,” undo, and then “Fade Sharpen More” operations in Adobe Photoshop can be used to initially sharpen the image. The “Fade Sharpen More” operation can be performed using, for example, a 50% fading factor. The above operations can provide an initial RGB image that better preserves the appearance of detail at the maximum resolution of 100 dpi. Thus, the above operations are effective in producing a “baseline” image for display on the display device. This method of sharpening, together with optimal scaling described above, could be used in fixed mode (1) described above. If the magnification factor is adjusted, however, the sharpening applied to this baseline image is also adjusted in accordance with the invention. If the sharpening is adjusted with magnification in conjunction with non-optimal (or “generic”) scaling, variable mode (2) can be achieved. Finally, if this dynamic sharpening is combined with optimal scaling as described above, optimal mode (3) is achieved.

Refinements to this process may provide improved results. One potential refinement is image-dependent sharpening. In particular, the characteristics of the sharpening function, and perhaps selection of one of several sharpening algorithms, can be based on the content of the image so as to optimize sharpness and minimize artifacts. For example, a predominantly sky blue image may dictate a sharpening algorithm that is different from that used for an image characterized by an indoor scene.

Another refinement may involve performing the process in a different sequence and RGB color space. An alternative sequence could involve conversion of CMYK image data to a linear RGB space, e.g., at 10- or 12-bit depth, followed by the scaling from file resolution to display resolution, sharpening, and conversion from linear RGB, e.g., at 10-bit depth, to an RGB color space at 8-bit depth and a gamma of 2.2. The potential advantage of this alternative sequence is that mathematical operations involving averaging and differences between pixels can be performed in the additive (linear) RGB color space. To avoid quantization, however, all calculations preferably are performed with better than 8-bit precision.

Sharpening of the original high resolution RGB image may not be required if significant zooming is employed. If a 300% or 400% magnification is permitted, for example, image detail generally will appear clearly to the viewer. Thus, for soft proofing, it is desirable to use a dynamic sharpening function that is dependent on magnification factor, combined with optimal scaling, to minimize artifacts and preserve the appearance of detail over a range of magnification factors.

As discussed above, a linear RGB space can be employed, providing a preprocess and post-process conversion of the RGB values to and from 12-bit depth, before and after the scale and sharpen steps. Assuming that an RGB working space with 2.2 gamma is utilized for converting CMYK->RGB in the first step, the pre- and post-processing steps for the red color channel would be:

R′=R(^{1/2.2)} Pre-process

R=R′^{2.2} Post-process

The green and blue channels would be handled in similar manner.

For optimal image reproduction for soft proofing purposes, dynamic sharpening is employed automatically for RGB data that has been converted from CMYK via accurate color management and smoothly scaled to the resolution of the display device. The level of sharpening is predetermined and dependent on the current magnification factor used for viewing the image. The level of sharpening can be determined consistent with the following general constraints:

(1) The level of sharpening should be adequate to provide reasonable appearance of detail and contrast in CMYK images rendered to the display in comparison to high resolution hard copies derived from the same image file.

(2) The level of sharpening should not create artifacts or distort the appearance of the image relative to the hard copy.

(3) The level of sharpening should decrease with increasing magnification in order to preserve the visual appearance of detail. Accentuating detail more than the visual detail present in the hard copy image is unacceptable. Likewise, reducing detail relative to the hard copy or “softening” is also to be avoided.

The sharpened image pixel values x′ₗⱼ may be computed as

$${x}_{ij}^{′} = {\sum }_{k = 1}^{k = 3} {\sum }_{l = 1}^{l = 3} {M}_{kl} {X}_{i + k - 2 , j + l - 2} ,$$

where the matrices X and M are

$$X = [ \begin{matrix}{x}_{i - 1 j - 1} & {x}_{i - 1 j} & {x}_{i - 1 j + 1} \\ {x}_{ij - 1} & {x}_{ij} & {x}_{ij + 1} \\ {x}_{i + 1 j - 1} & {x}_{i + 1 j} & {x}_{i + 1 j + 1}\end{matrix} ]$$

$$M = [ \begin{matrix}0 & - α / 4 & 0 \\ - α / 4 & 1 + α & - α / 4 \\ 0 & - α / 4 & 0\end{matrix} ]$$

and x_{lJ} is the original pixel value at the i^{th} column, j^{th} row. The parameter α controls the degree of sharpening and has a nominal value of 1.0. The sharpened image's pixel values x′ₗⱼ must be clipped to the permitted range of x_{lj,} typically [0,255] or [0,1].

According to this approach, the value α varies according to the magnification factor of the display device. In this manner, the sharpening function is controlled as a function of the magnification factor. If Z is the magnification factor and α controls the degree of sharpening, the relationship can be represented as:

α=α₁₀₀*(1−(Z−100)/(Zₘₐₓ−100))

where α₁₀₀ is the optimal sharpening at 100% magnification, Z is the zoom factor, Zₘₐₓ is the maximum zoom feasible resulting in displaying the pixels at the native high resolution of the CMYK in “actual pixels” mode of the display. The sharpening coefficient α can be calculated on-the-fly in response to changes in the magnification factor Z. Alternatively, a lookup table of precomputed sharpening coefficients α can be provided. In this case, the lookup table maps different values of the magnification factor Z to corresponding sharpening coefficients α. Adjustment of the sharpening coefficient α is then simply a matter or correlation and retrieval via the lookup table.

To achieve a more adequate visual match between hard copy and display in terms of detail, sharpness, contrast, and the like, another feature may be desirable in conjunction with the automated sharpening function described above. In particular, this additional modification may involve incorporating within the profile utilized to characterize the display device, e.g., an ICC profile, an adjustment that provides more appropriate characterization of dark colors relative to a perfect black.

Most standard CRT device profiles, such as those provided by Apple Computer and most CRT manufacturers, map RGB=0 to XYZ=0 and hence L*=0. This may appear to be justified based on calorimetric measurement. For example, a measuring device may indeed indicate undetectable light emitted from a display at RGB=0. In reality, however, when a region of RGB=0 is displayed adjacent to regions of RGB>0, or especially regions of RGB=white, multiple reflections from the surface of the display will in fact present to a human observer a faint gray appearance in regions of RGB=0. Thus, the device does not necessarily produce a perfect black for RGB=0. Furthermore, for reasonable settings of a CRT, RGB=0 may have a slight glow that is subtracted out by a measurement or profiling system.

Thus, rather than assuming a simplistic expression for the one-dimensional response of R, G, and B such as:

R′=R^{γ}

(and similarly for G and B), where R is the normalized digital value and R′ is in “linear RGB space,” i.e., linear with measured XYZ, a non-zero offset can be assumed to indicate that RGB=0 is not a perfect black, in accordance with another aspect of the invention. Instead, RGB=0 may be effectively equivalent to L*=10 or L*=15:

R′=Rₘₘ+(1.0−Rₘₘ)R^{γ}

(and similarly for G and B). Note that in order to demonstrate this modification using commercially available software such as Adobe PhotoShop, it is often necessary to construct a LUT in the device profile containing, for example, 1028 entries for smooth precision, and to force the value of the first entry (RGB=0) to be 0. One can speculate that this is necessary in certain applications because the non-zero offset indicated above may be automatically scaled out by the software application before applying color management. This is because the software application may assume that the offset is unintentional, for example, due to misinterpretation of the ICC specification. Hence, the function used to create the LUT can be:

R′=Rₘₘ+(1.0−Rₘₘ)R^{γ}

for

(R>0)

R′=0

for

(R=0)

(and similarly for G and B). Thus, the profile for the display device can be adjusted to compensate for differences between the darkest color values reproducible by the device and a perfect black. In this manner, a non-zero offset is introduced for values of R, G, and B in the vicinity of zero. The values of Rₘᵢₙ, Gₘᵢₙ, and Bₘᵢₙ can be empirically determined in a manner similar to the appropriate degree of sharpening. Unlike the sharpening function, however, this offset correction can be made globally for all degrees of magnification since it is more closely related to the actual color response of the system and generally independent of image resolution.

Various embodiments of the invention have been described. These and other embodiments are within the scope of the following claims.

1. A method comprising:
applying a sharpening function to an image; and
controlling the sharpening function based on a magnification factor associated with the image.

2. The method of claim 1, wherein controlling the sharpening function includes adjusting a degree of sharpening based on the magnification factor.

3. The method of claim 1, wherein controlling the sharpening function includes adjusting a degree of sharpening in inverse proportion to the magnification factor.

4. The method of claim 1, further comprising adjusting a profile for a display device that presents the image to compensate for differences between the darkest color values produced by the display device and a perfect black.

5. A system comprising:
a display device that displays a representation of a color image; and
a processor that applies a sharpening function to the color image, wherein the processor controls the sharpening function based on a magnification factor associated with the color image.

6. The system of claim 5, wherein the processor controls the sharpening function includes adjusting a degree of sharpening based on the magnification factor.

7. The system of claim 5, wherein the processor controls the sharpening function includes adjusting a degree of sharpening in inverse proportion to the magnification factor.

8. The system of claim 5, wherein the profile for a display device that presents the color image has been adjusted to compensate for differences between the darkest color values produced by the display device and a perfect black.

9. A computer-readable medium containing instructions that cause a programmable processor to:
apply a sharpening function to an image; and
control the sharpening function based on a magnification factor associated with the image when presented on a display device.

10. The computer-readable medium of claim 9, wherein the instructions cause the processor to control the sharpening function by adjusting a degree of sharpening based on the magnification factor.

11. The computer-readable medium of claim 9, wherein the instructions cause the processor to control the sharpening function by adjusting a degree of sharpening in inverse proportion to the magnification factor.

12. The computer-readable medium of claim 9, wherein the instructions cause the processor to adjust a profile for a display device that presents the image to compensate for differences between the darkest color values produced by the display device and a perfect black.

13. A method comprising:
selecting one of a plurality of operating modes for a soft proofing system;
selecting a scaling function for an image to be presented by the soft proofing system based on the selected operating mode; and
selecting a sharpening function for the image based on the selected operating mode.

14. The method of claim 13, wherein one of the operating modes comprises a fixed magnification factor mode in which the soft proofing system presents the image with a fixed magnification, and wherein selecting a scaling function includes selecting an optimal scaling function when the selected operating mode is the fixed magnification factor mode.

15. The method of claim 14, wherein the optimal scaling function comprises a bicubic interpolation function.

16. The method of claim 13, wherein one of the operating modes comprises a fixed magnification factor mode in which the soft proofing system presents the image with a fixed magnification, and wherein selecting a sharpening function includes selecting a fixed sharpening function that is independent of the magnification factor when the selected operating mode is the fixed magnification factor mode.

17. The method of claim 13, wherein one of the operating modes comprises a variable magnification factor mode in which the soft proofing system presents the image with a variable magnification factor, and wherein selecting a scaling function includes selecting a generic scaling function when the selected operating mode is the variable magnification factor mode.

18. The method of claim 17, wherein the generic scaling function includes one of a bicubic interpolation function and a nearest neighbor interpolation function.

19. The method of claim 17, wherein one of the operating modes comprises a variable magnification factor mode in which the soft proofing system presents the image with a variable magnification factor, and wherein selecting a sharpening function includes selecting a dynamic sharpening function that is dependent on the magnification factor when the selected operating mode is the variable magnification factor mode.

20. The method of claim 19, further comprising selecting the sharpening function by adjusting a degree of sharpening based on the magnification factor.

21. The method of claim 13, wherein one of the operating modes comprises an optimal mode in which the soft proofing system presents the image with a variable magnification factor, and wherein selecting a scaling function includes selecting an optimal scaling function when the selected operating mode is the optimal mode, and selecting a sharpening function includes selecting a dynamic sharpening function that is dependent on the magnification factor when the selected operating mode is the optimal mode.

22. The method of claim 21, wherein the optimal scaling function comprises a bicubic interpolation function.

23. The method of claim 21, further comprising selecting the sharpening function by adjusting a degree of sharpening based on the magnification factor.

24. A system comprising:
a display device that displays a representation of a color image; and
a processor that selects one of a plurality of operating modes, selects a scaling function for the color image to be presented by the display device based on the selected operating mode, and selects a sharpening function for the color image based on the selected operating mode.

25. The system of claim 24, wherein one of the operating modes includes a fixed magnification factor mode in which the display device presents the image with a fixed magnification, and the processor selects an optimal scaling function when the selected operating mode is the fixed magnification factor mode.

26. The system of claim 25, wherein the optimal scaling function comprises a bicubic interpolation function.

27. The system of claim 24, wherein one of the operating modes comprises a fixed magnification factor mode in which the display device presents the image with a fixed magnification, and the processor selects a fixed sharpening function that is independent of the magnification factor when the selected operating mode is the fixed magnification factor mode.

28. The system of claim 24, wherein one of the operating modes comprises a variable magnification factor mode in which the display device presents the image with a variable magnification factor, and the processor selects a generic scaling function when the selected operating mode is the variable magnification factor mode.

29. The system of claim 28, wherein the generic scaling function includes one of a bicubic interpolation function and a nearest neighbor interpolation function.

30. The system of claim 24, wherein one of the operating modes comprises a variable magnification factor mode in which the display device presents the image with a variable magnification factor, and the processor selects a dynamic sharpening function that is dependent on the magnification factor when the selected operating mode is the variable magnification factor mode.

31. The system of claim 30, wherein the processor selects the sharpening function by adjusting a degree of sharpening based on the magnification factor.

32. The system of claim 24, wherein one of the operating modes comprises an optimal mode in which the display device presents the image with a variable magnification factor, and the processor selects an optimal scaling function when the selected operating mode is the optimal mode, and a dynamic sharpening function that is dependent on the magnification factor when the selected operating mode is the optimal mode.

33. The system of claim 32, wherein the optimal scaling function comprises a bicubic interpolation function.

34. The system of claim 32, wherein the processor selects the sharpening function by adjusting a degree of sharpening based on the magnification factor.

35. A computer-readable medium comprising instructions that cause a programmable processor to:
select one of a plurality of operating modes for a soft proofing system;
select a scaling function for an image to be presented by the soft proofing system based on the selected operating mode; and
select a sharpening function for the image based on the selected operating mode.

36. The computer-readable medium of claim 35, wherein one of the operating modes is a fixed magnification factor mode in which the soft proofing system presents the image with a fixed magnification, and the instructions cause the processor to select a scaling function includes selecting an optimal scaling function when the selected operating mode is the fixed magnification factor mode.

37. The computer-readable medium of claim 36, wherein the optimal scaling function is a bicubic interpolation function.

38. The computer-readable medium of claim 35, wherein one of the operating modes is a fixed magnification factor mode in which the soft proofing system presents the image with a fixed magnification, and the instructions cause the processor to select a fixed sharpening function that is independent of the magnification factor when the selected operating mode is the fixed magnification factor mode.

39. The computer-readable medium of claim 35, wherein one of the operating modes comprises a variable magnification factor mode in which the soft proofing system presents the image with a variable magnification factor, and the instructions cause the processor to select a generic scaling function when the selected operating mode is the variable magnification factor mode.

40. The computer-readable medium of claim 39, wherein the generic scaling function includes one of a bicubic interpolation function and a nearest neighbor interpolation function.

41. The computer-readable medium of claim 39, wherein one of the operating modes comprises a variable magnification factor mode in which the soft proofing system presents the image with a variable magnification factor, and the instructions cause the processor to select a dynamic sharpening function that is dependent on the magnification factor when the selected operating mode is the variable magnification factor mode.

42. The computer-readable medium of claim 41, and the instructions cause the processor to select the sharpening function by adjusting a degree of sharpening based on the magnification factor.

43. The computer-readable medium of claim 35, wherein one of the operating modes comprises an optimal mode in which the soft proofing system presents the image with a variable magnification factor, and the instructions cause the processor to select an optimal scaling function when the selected operating mode is the optimal mode, and select a dynamic sharpening function that is dependent on the magnification factor when the selected operating mode is the optimal mode.

44. The computer-readable medium of claim 43, wherein the optimal scaling function is a bicubic interpolation function.

45. The computer-readable medium of claim 43, wherein the instructions cause the processor to select the sharpening function by adjusting a degree of sharpening based on the magnification factor.

46. A method comprising:
applying an interpolation-based scaling function to an image to be presented by a soft proofing system; and
applying a dynamic sharpening function to the image, wherein the dynamic sharpening function is adjusted according to a magnification factor of the image.

47. A method comprising:
applying an interpolation-based scaling function to an image to be presented by a soft proofing system; and
applying a fixed sharpening function to the image, wherein the fixed sharpening function is independent of a magnification factor of the image.

48. A method comprising:
applying an non-interpolation-based scaling function to an image to be presented by a soft proofing system; and
applying a dynamic sharpening function to the image, wherein the dynamic sharpening function is adjusted according to a magnification factor of the image.
